(19) United States
(12) Patent Application Publication
(10) Pub. No.: US 2013/0041951 A1
(43) Pub. Date: Feb. 14, 2013

(54) HOME APPLIANCE AND METHOD OF OPERATING THE SAME

(71) Applicants: Gunho Lee, Gyeonggi-do (KR); Kyongjo Jung, Gyeonggi-Do (KR)

(72) Inventors: Gunho Lee, Gyeonggi-do (KR); Kyongjo Jung, Gyeonggi-Do (KR)

(21) Appl. No.: 13/483,917

(22) Filed: May 30, 2012

(30) Foreign Application Priority Data
Aug. 10, 2011 (KR) 10-2011-0079844

(51) Int. Cl. G06F 15/16; G05B 15/02

(52) U.S. Cl. 709/204

(57) ABSTRACT

A method of operating a home appliance according to an aspect of the invention may include checking a message included in at least one of an Internet service server and an Internet service page while the home appliance uses an account thereof set beforehand, authenticating the message whereby it is checked whether an account in which the message is written has a predetermined relationship with the account of the home appliance, and executing a control command to control the home appliance according to the message, the control command analyzed based on the message.

### CROSS-REFERENCE TO RELATED APPLICATION

This application claims the benefit of Korean Patent Application No. 10-2011-0079844, filed on Aug. 10, 2011, which is hereby incorporated by reference for all purposes as if fully set forth herein.

### BACKGROUND OF THE INVENTION

1. Field of the Invention

The present invention relates to a home appliance and a method of operating the same, and particularly, to a home appliance that can be controlled by various Internet services with which an account of the home appliance is registered, and a method of operating the same.

2. Background of the Invention

Various methods have been discussed in order to control home appliances remotely. Research has been conducted to facilitate remote control.

However, according to the existing methods, home appliances can be remotely controlled only when specific programs are installed in both home appliances and a user's terminal. That is, remote control is possible only with particular programs agreed between a user and a home appliance. Thus, remote control is impossible unless the user has a terminal with a particular program installed therein.

In line with the rapid spread of smart home appliances, functions performed by smart home appliances have been diversified. Therefore, a variety of functions according to the user's needs as well as particular functions need to be input remotely.

### SUMMARY OF THE INVENTION

Therefore, an aspect of the detailed description is to provide a home appliance that can be remotely controlled using various units and a method of operating the same.

An aspect of the present invention also provides a home appliance whose status can be checked using various units and a method of operating the same.

An aspect of the present invention also provides a home appliance that can be controlled without installing a specific unit and a method of operating the same.

An aspect of the present invention also provides a home appliance that can be controlled and whose status can be checked in interoperation with another home appliance and a method of operating the same.

To achieve these and other advantages and in accordance with the purpose of this specification, as embodied and broadly described herein, a home appliance and a method of operating the same are provided.

According to an aspect of the present invention, there is provided a method of operating a home appliance, the method including: checking a message included in at least one of an server of Internet service and an page of Internet service while the home appliance uses an account thereof set beforehand; authenticating the message whereby it is checked whether an account in which the message is written has a predetermined relationship with the account of the home appliance; and executing a control command to control the home appliance according to the message, the control command analyzed based on the message.

The checking of the message may include logging on to the server of Internet service while the home appliance uses the account thereof set beforehand.

The method may further include creating a message including at least one of collection information and status information of the home appliance; and sending the message to display the message on an Internet service.

The method may further include creating a message corresponding to a result when the home appliance executes the control command; and sending the message to display the message on an Internet service.

The result of executing the control command may be at least one of collection information and status information of the home appliance.

An Internet service may be at least one of social network service (SNS), email service, and messenger service.

The page of Internet service may be an email received at the account of the home appliance in case of the email service, a message received at the account of the home appliance in case of the messenger service, and a website in association with the account of the home appliance in case of the social network service.

The method may further include sending a confirmation message containing the control command analyzed; and receiving a response message to the confirmation message from a user.

The method may further include sending a message to request re-input to the Internet service.

The method may further include sending a confirmation message containing a result of executing the control command; and receiving a response message to the confirmation message from a user.

The method may further include sending a message requesting re-input to the Internet service.

The message may be an interactive sentence.

According to another aspect of the present invention, there is provided a home appliance including a communication unit establishing connection to a network; a storage unit storing information about an account of the home appliance and information about a user account stored to have a predetermined relationship with the account of the home appliance in an server of Internet service; and a control unit functionally connected to the communication unit and the storage unit, wherein the control unit checks a message included in at least one of the server of Internet service and an page of Internet service by using the information about the account of the home appliance, acquires a message displayed by the user account from at least one of the server of Internet service and the page of Internet service, and executes a control command to control the home appliance according to the message while the control command is analyzed based on the message.

The control unit may create a message corresponding to a result of executing the control command and send the message to display the message on an Internet service.

The control unit may send a confirmation message containing the control command analyzed.

The home appliance may be a television, a radio, a computer, a refrigerator, a washing machine, an air conditioner, or a cleaner.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

### BRIEF DESCRIPTION OF THE DRAWINGS

The accompanying drawings, which are included to provide a further understanding of the invention and are incorporated in and constitute a part of this specification, illustrate exemplary embodiments and together with the description serve to explain the principles of the invention.

In the drawings:

FIG. 1 is a diagram illustrating a home appliance control system using Internet services;

FIGS. 2A to 2C are views illustrating that a user leaves a message on an Internet service page;

FIG. 3 is a block diagram illustrating a home appliance to which an embodiment of the present invention is applicable;

FIGS. 4A to 4C are a flowchart illustrating a method of operating a home appliance in connection with an embodiment of the present invention and views illustrating a message left in each operation;

FIGS. 5A and 5B are views illustrating a message indicating a user requests status information of the home appliance and a message according to a result thereof;

FIGS. 6A to 6C are views illustrating a process to check if the extracted control command coincides with user's intentions;

FIGS. 7A and 7B are views illustrating an embodiment when a message that instructs a home appliance to repeat at a predetermined cycle is input;

FIG. 8 is a view illustrating that a user inputs operating messages with conflicting contents by SNS;

FIGS. 9A to 9C are views illustrating that a user checks the status of a home appliance and controls the home appliance by using two types of Internet services; and

FIG. 10 is a diagram illustrating a system in which the operation of a home appliance is controlled while one home appliance interoperates with other home appliance.

### DETAILED DESCRIPTION OF THE INVENTION

The terms used in this specification will be described in brief, and description will now be given in detail of the exemplary embodiments, with reference to the accompanying drawings.

Although the terms used in the present invention are selected from generally known and used terms considering their functions in the present invention, the terms may be modified depending on intention of a person skilled in the art, practices, or the advent of new technology. In addition, terms that are arbitrarily chosen by applicants are used in a particular case, where the meanings of these terms will be described in detail in the detailed description of the invention. Therefore, the terms used in the present invention are to be defined based on meanings of the terms and the general understandings of the present invention, but not simply as the names of the terms.

Throughout the specification, when it is described that a part “includes” an element and there is no opposite description thereof, it is not seen that the part excludes other elements but it is seen that the part can further include other elements. Also the term of “part”, “-er” or “module” indicates a unit for processing at least one function or operation.

Hereinafter, preferred embodiments of the present invention will be described with reference to the accompanying drawings to fully explain the present invention in such a manner that it may easily be carried out by a person with ordinary skill in the art to which the present invention pertains. The invention may, however, be embodied in many different forms and should not be construed as being limited to the embodiments set forth herein. Portions irrelevant to the description are omitted in order to clarify the present invention, and like reference numerals are used for referring to the same or similar elements in the specification.

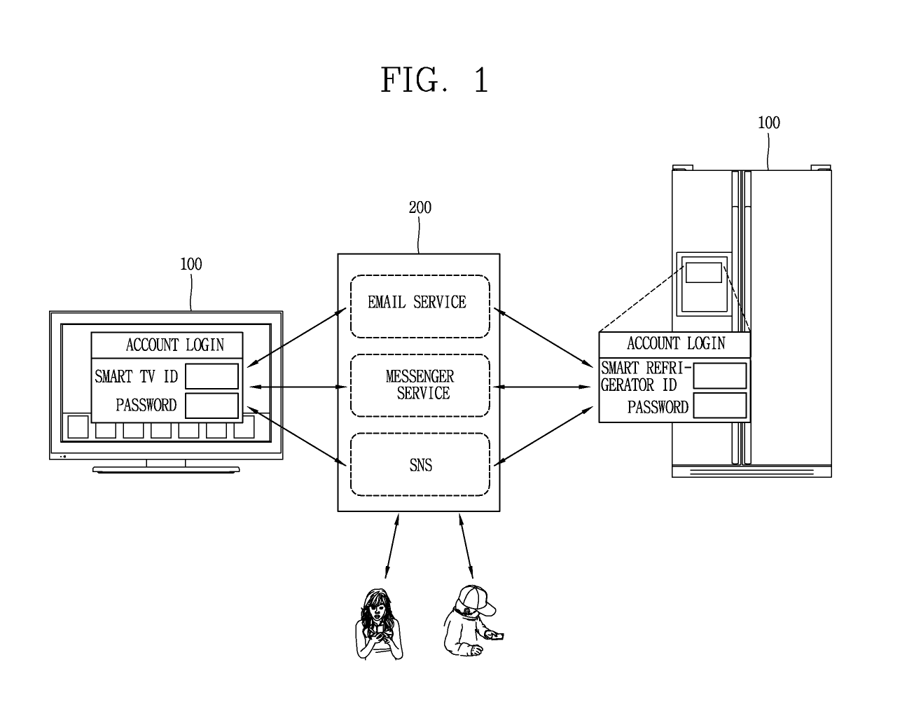

FIG. 1 is a diagram illustrating a home appliance control system using Internet services. The home appliance control system may include a home appliance 100 and Internet services 200.

“Home appliances” used through this specification may include televisions, radios, computers, refrigerators, washing machines, air conditioners, and cleaners. These home appliances may include devices to gain access to the Internet.

In addition, an account may be created and used for each home appliance. Alternatively, a particular user account may be used as an account of each home appliance. The account of each home appliance may be registered with at least one Internet service.

Meanwhile, a user of the home appliance may register for at least one Internet service with the account of the home appliance. At least one user may use the home appliance.

‘Internet services’ used throughout the specification may include email service, messenger service, and social network service (SNS). In addition, Internet services may include any type of service by which a user can send a message and the other user can read the message online.

Referring to FIG. 1, a user does not directly access a home appliance and control the home appliance. The user may leave a message to the Internet service and read a message left by the home appliance. The home appliance may check the message sent by the user via the Internet service and leave status information of the home appliance and a result of executing a job by the Internet service.

When home appliances are controlled by the existing Internet services such as Email service, messenger service, and SNS, these home appliances can be readily controlled using the existing Internet services without installing additional devices. In addition, a separate device is not needed to gain access to a home appliance using various client devices.

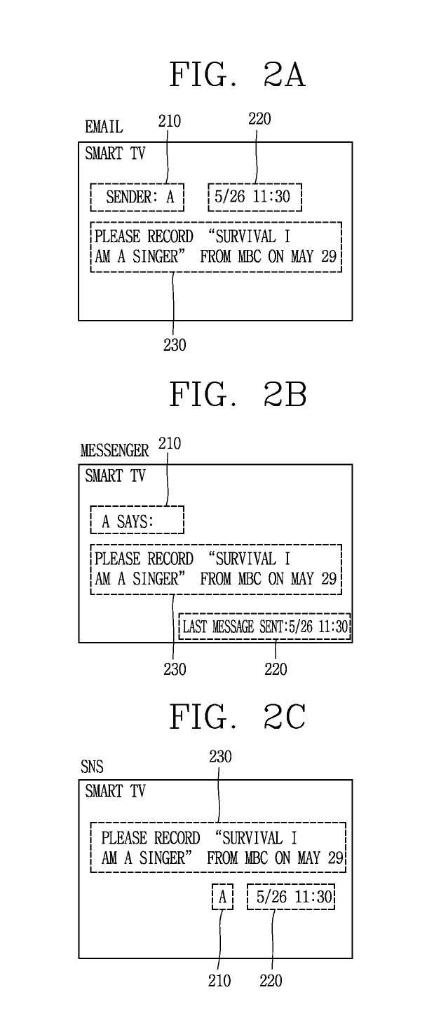

FIGS. 2A to 2C are views illustrating that a user leaves a message on an Internet service page. FIG. 2A is a view showing a case in which a message is left in an account of a home appliance by email. FIG. 2B is a view showing a case in which a message is left in an account of a home appliance by messenger service. FIG. 2C is a view showing a case in which a message is left in an account of a home appliance by SNS.

Internet services may provide individual Internet service pages according to each service. For example, in case of email service, an email writing page and a new message reading page may correspond to one of the Internet service pages. In case of messenger service, a chat window may correspond to one of the Internet service pages. In case of SNS, websites provided according to each account may correspond to one of the Internet service pages.

In FIGS. 2A to 2C, the same writer (user account) 210 leaves messages having the content 230 in individual Internet service pages at the same date and time 220.

Email service, messenger service, and SNS have their own display formats. Therefore, a controller of the home appliance may classify the messages left by the user account according to the writer 210, the content 230, and the date and time 220. The user account into the writer 210, the content 230, and the date and time 220 may be used for the controller to drive the home appliance. The detailed operation thereof will be reviewed in association with specific embodiments.

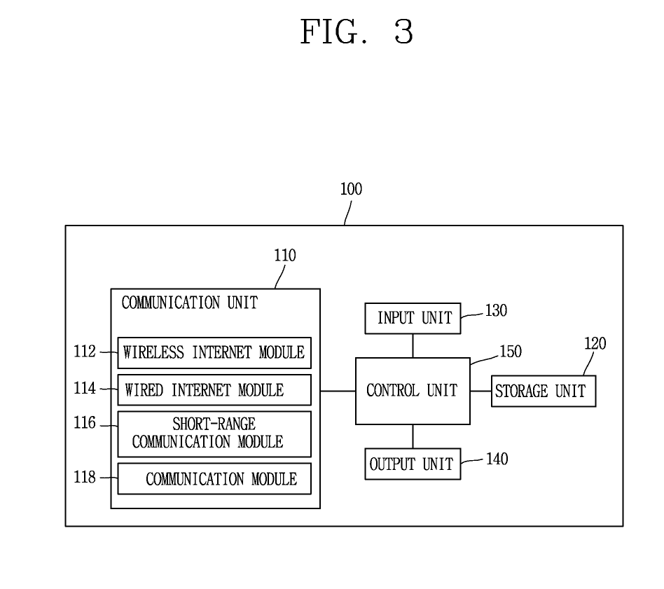

FIG. 3 is a block diagram illustrating a home appliance to which an embodiment disclosed in the specification can be applied.

The home appliance 100 may include a communication unit 110, a storage unit 120, an input unit 130, an output unit 140, and a control unit 150.

The components shown in FIG. 3 are provided to constitute an aspect of the invention disclosed in this specification, but a home appliance that has a smaller or larger number of components than the home appliance according to the aspect of the invention may be provided.

Hereinafter, the above-described components will now be described in order.

The communication unit 110 may establish connection to a network or perform communication with another appliance. The communication unit 10 may include a wireless Internet module 112, a wired Internet module 114, a short-range communication module 16, and a communication module 118.

The wireless Internet module 112 is provided to gain wireless Internet connection. The wireless Internet module 112 may be installed internally or externally. Wireless Internet technologies may include WLAN (Wireless LAN) (Wi-Fi), Wibro (Wireless broadband), Wimax (World Interoperability for Microwave Access), and HSDPA (High Speed Downlink Packet Access).

The wired Internet module 114 is provided for wired Internet connection. The wired Internet module 114 may be provided internally or externally.

Hereinafter, the wireless Internet module 112 and the wired Internet module 114 are commonly called ‘Internet modules.’

The short-range communication module 116 is provided for short-range communication. short-range communication technologies may include Bluetooth, RFID (Radio Frequency Identification), IrDA (infrared Data Association), visible light communication, UWB (Ultra Wideband), and ZigBee.

The communication module 118 transmits and receives signals to and from at least one of a base station, external home appliance, and a server on a communication network. The signals may include various types of data through the transmission and reception of a voice call signal, a video call call signal, and text/MMS messages.

The storage unit 120 may store various kinds of data that are required for the home appliance to operate. For example, when a home appliance gains access to the Internet, login information about an account of the home appliance is required, and therefore, the storage unit 120 may store the login information of the home appliance. Also, the storage unit 120 may store user account information on a user who is allowed to control the home appliance. In addition, when it is confirmed that a user has input a particular message with respect to the account of the home appliance on the Internet service, the storage unit 112 may store the message. When a control command is extracted from the message, the storage unit 120 may store the extracted control command. In addition, when the control command needs to be repeated at a predetermined cycle, cycle information may be stored in the storage device 120.

The storage unit 120 may include a storage medium of at least one type of flash memory type, hard disk type, multimedia card micro type, card type memory (for example, SD or XD memory), RAM (Random Access Memory), SRAM operation Static Random Access Memory), ROM (Read-Only Memory), EEPROM (Electrically Erasable Programmable Read-Only Memory), PROM (Programmable Read-Only Memory), magnetic memory, magnetic disk, and optical disk. The home appliance 100 may operate in conjunction with web storage that functions as a storage of the storage unit 120 on the Internet.

The input unit 130 may generate input data for the user to control the operation of the home appliance. For example, when the user inputs messages with conflicting contents in association with the operation of the home appliance, a procedure by which the operation of the home appliance is performed in relation to the messages may be input using the input unit 130. The input unit 130 may be configured into a key pad, a dome switch, a touch pad (constant pressure/static electricity), a jog wheel, or a jog switch.

The output unit 140 may display(output, etc.) information(collection information, etc.) processed in the home appliance 100 and the status(status information, etc.) of the home appliance. At this time, the collection information may include various kinds of information collected by the home appliance on the Internet or collected by another home appliance connected to the above-described home appliance. For example, when the user instructs the home appliance to search a particular word on the Internet, information searched according to the corresponding word on the Internet can be collection information. Also, the status information may include various kinds of information showing the status of the home appliance. For example, the status information may include the total TV usage for this month and a recording reservation list.

The control unit 150 controls the general operation of the home appliance.

The control unit 150 may perform control such that the home appliance accesses the Internet services, using its account information included in the storage unit 120. The access to the Internet services may be periodically performed. Alternatively, the home appliance may stay connected to the Internet services.

Meanwhile, there is an Internet service that requires a login procedure in order to check a page related to the account of the home appliance. In this case, the control unit 150 may perform control such that the home appliance undergoes a login procedure.

In addition, the control unit 150 may check whether a message has been left in the account of the home appliance. This can be done by an Internet service server(server of internet service) and an Internet service page(page of Internet service). Alternatively, when a message is left in the account of the home appliance, the home appliance may receive a notification message.

In addition, the control unit 150 may compare account information of a user who has left a message in the account thereof with a user account stored in the storage unit 120. The user account that is stored in the storage unit 120 is allowed to instruct the home appliance to operate. Through this comparison, the control unit 150 can check if the message needs to be processed by the home appliance (message authentication). Among the Internet services, there is a service with which anyone can write a message. Therefore, through the checking procedure, it can be checked if the message has been written by the user who is allowed to control the home appliance.

In addition, the control unit 150 may perform control such that the communication unit 110 can receive information necessary from the Internet service server and the Internet service page regarding the account of the home appliance. The information may contain a message writer, message writing date and time, and a message content.

The control unit 150 may also extract a control command from the message content to control the home appliance. The extraction procedure may be performed according to a natural language processing method. Alternatively, the user may additionally store a message analysis method to the storage unit 120.

All the functions that can be performed by each home appliance may be expressed into individual control commands. For example, in the case of TV, control commands corresponding to all the functions of TV, including scheduling recordings, power on/off, changing channels, and adjusting volume, may be created. In addition, a control command that instructs the home appliance to collect information required by the user on the Internet instead of the user may be created.

The control unit 150 may perform control such that the home appliance executes the control command.

The control unit 150 may create a message corresponding to a result obtained after the home appliance executes the control command. In addition, the control unit 150 may perform control so that the communication unit 110 sends the created message.

Hereinafter, embodiments related to a control method that can be performed in a terminal configured as described above will be described with the accompanying drawings. Embodiments to be described below can be used singly or in combination. Also, though a description is made mainly to one of the Internet services, since the content of the message that may be included in each Internet service is the same, an example of driving a home appliance on the basis of one service in the specification is applicable to another service.

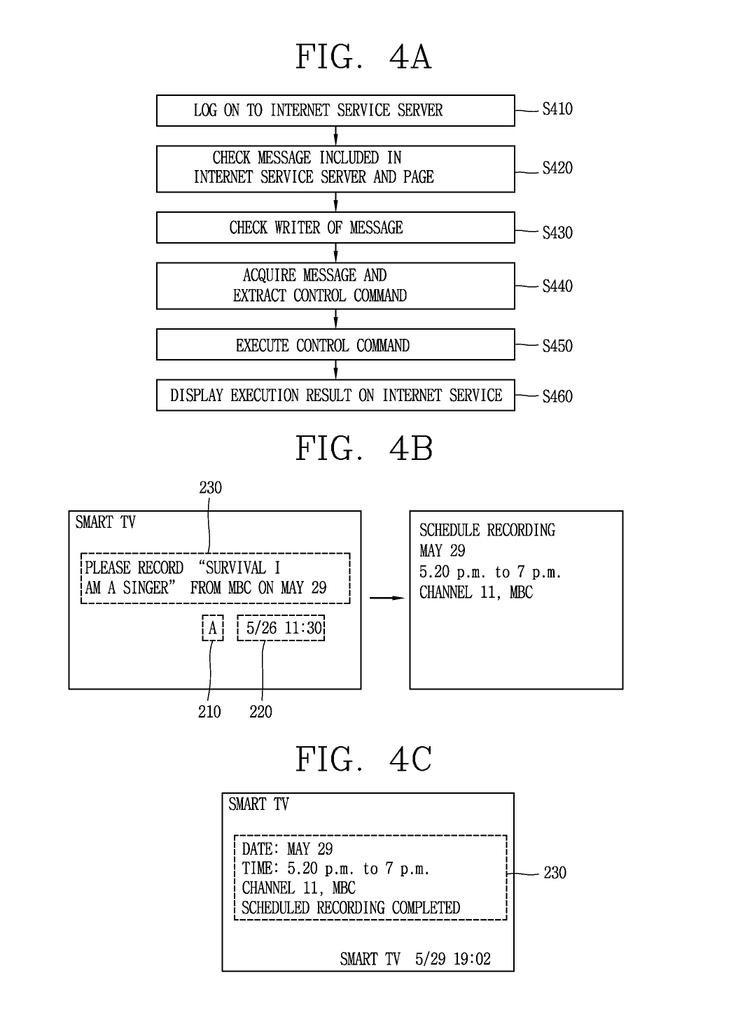

FIG. 4A is a flowchart illustrating a method of operating a home appliance according to an embodiment of the present invention. FIG. 4B is a view illustrating a type of message that is left by a user and a control command that is extracted from the message. FIG. 4C is a view illustrating a message corresponding to a result of executing a control command by the Internet service.

A method of operating a home appliance according to an embodiment of the present invention may include logging on to an Internet service server by a home appliance in operation S410, checking a message included in an Internet service server and an Internet service page related to an account of the home appliance in operation S420, authenticating a writer of the message in operation S430, acquiring the message and extracting a control command from the message in operation S440, executing the control command in operation S450, and displaying a result of executing the control command on the Internet service in operation S460.

The login process in operation S410 may be performed using information about the account of the home appliance that is stored in the storage unit 120.

The control unit 150 may perform control such that the communication unit of the home appliance gains access to the Internet service server. In addition, during a login requiring process, the control unit 150 may perform control to input the account information of the home appliance.

The login process in operation S410 may be performed for a service that requires login to check a message left in the account. In the case of a service in which the message left in the account can be checked without logging in, the login process may be omitted.

After the login process in operation S410, the message included in the Internet service server and the Internet service page related to the account of the home appliance can be checked. When the home appliance gains access to the Internet service server at a predetermined cycle, a message subsequent to previous access time can be checked. If the home appliance stays connected to the Internet service, every time a new message is created, the message can be checked. As shown in FIG. 4B, the message may contain the writer 210, the date and time 220, and the content 230.

After the message checking process in operation S420, the home appliance may authenticate the writer of the message in operation S430. The authentication process may be performed by checking whether the writer of the message is present in a user account information list that is stored in the storage unit 120. Alternatively, the authentication process may be performed by checking whether the account of the home appliance and the account of the writer of the message have a prescribed relationship with each other in the Internet server. By the authentication process in operation S430, the indiscriminate control of the home appliance by a third party can be prevented.

After the authentication process in operation S430, the control unit 150 may extract the control command from the content of the message in order to control the home appliance in operation S440. The extraction process may be performed on the basis of a natural language processing method. Alternatively, a user may additionally store a message analysis method to the storage unit 120. Referring to FIG. 4B, it can be checked that the content of the control command is extracted on the basis of the content 230.

After the extraction process in operation S440, the control unit 150 may execute the control command. Since each home appliance has its unique function, each control command may be varied according to each home appliance.

After executing the control command in operation S450, the control unit 150 may show a result of the execution to the Internet service. The execution result may be displayed on at least one of the several Internet services with which the account of the home appliance is registered. Also, the execution result may be shown to the account of the user who has left the message as well as the account of the home appliance. In addition, in addition to the user who has left the message, the execution result may be designed to be displayed on at least one account of the users registered as users of the home appliance. As the execution result is displayed on a larger number of Internet services, the user can check the execution result of the home appliance more quickly and easily. In addition, as the execution result is shown to a larger number of user accounts, various users related to the home appliance can check the execution result of the home appliance.

The detailed requirements regarding the report of the result may be determined beforehand by the input unit 130. Also, the detailed requirements in terms of showing the result may be input to the content of the message.

Referring to FIG. 4C, it can be checked that the home appliance has shown the execution result to the account thereof by the control command.

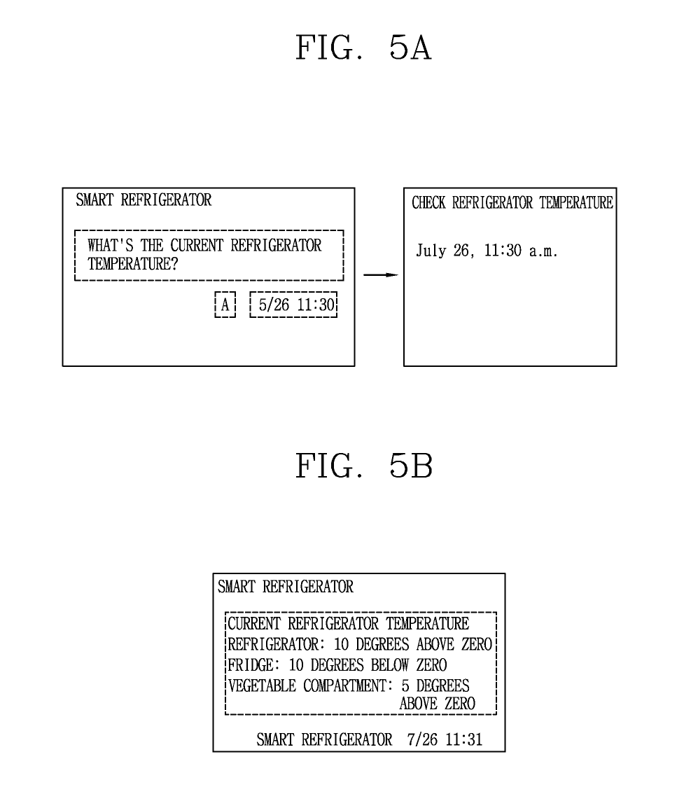

FIG. 5A is a view showing a message when a user requests status information of a home appliance. FIG. 5B is a view showing a result message according to the message of FIG. 5A.

FIG. 5A is a view showing one example in which a user leaves a message in connection with one embodiment of the present invention and a control command is extracted from the message. FIG. 5B is a view illustrating a message corresponding to status information that is left by the home appliance by using the Internet service.

Referring to FIG. 5A, it is shown that the user is making a request for status information of the home appliance. Even when the user leaves a message requesting status information of the home appliance, a result message is output by the same procedure shown in FIG. 4A, and thus the detailed flowchart will be omitted.

When the user leaves a message to request the status information of the home appliance, the message checking process in operation S420 and the control command extr action process in operation S440 a s shown in FIG. 4A can be expressed in detail as shown in FIG. 5A.

Referring to FIG. 5A, the control unit 150 may be aware from the message that the user has made a request for temperature information of a refrigerator. The control unit 150 may then extract the control command indicating that the temperature information of the refrigerator should be displayed on the basis of the message.

In the execution result displaying process in operation S460 as shown in FIG. 4A, the message as shown in FIG. 5B may be shown. With reference to FIG. 5B, it can be seen that temperature according to each compartment of the refrigerator is displayed according to the user's intentions.

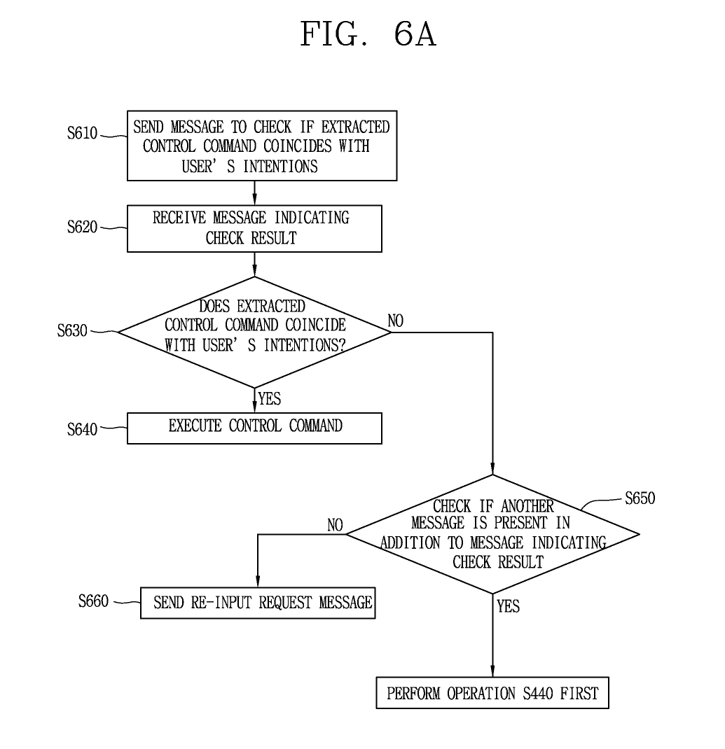

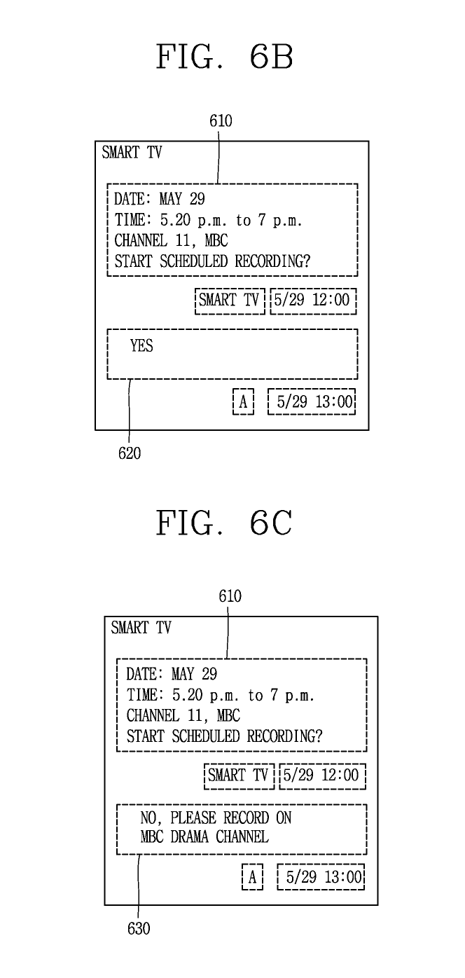

FIGS. 6A to 6C are views illustrating a process of checking whether the extracted control command coincides with the user's intentions.

In the present invention, a user may input a specific command, but the control unit may extract a control command through an interactive sentence. Since a control command that does not coincide with the user's intentions can be extracted during the process of extracting the control command, a confirmation process needs to be performed to see whether the extracted control command coincides with the user's intentions.

The process performed to check if the extracted control command coincides with the user's intentions may be performed between the control command extraction process in operation S440 and the control command execution process in operation S450 as shown in FIG. 4A.

Referring to FIG. 6A, the process performed to check if the extracted control command coincides with the user's intentions may include a process in which a message is sent to check whether the extracted control command coincides with the user's intentions in operation S610, a process in which a message indicating a check result is received in operation S620, and a process in which the check result is confirmed in operation S630. For example, a confirmation message 610 may be displayed as shown in FIGS. 6A and 6C. Also, a positive message 620 indicating that the extracted control command coincides with the user's intentions may be displayed as shown in FIG. 6B. A negative message 630 indicating that the extracted control command does not coincide with the user's intentions may be displayed as shown in FIG. 6C. The negative message 630 may include a re-input message. The re-input message allows the user to give another instruction regarding the operation of the home appliance when the extracted control command does not coincide with the user's instructions.

The check result confirmation process in operation S630, when it is checked that the positive message 620 indicating that the extracted control command coincides with the user's intentions is received, the home appliance may execute the control command in operations S640 and S450.

In the check result confirmation process in operation S630, when it is confirmed that the message 630 indicating that the extracted control command does not coincide with the user's intentions is received, the home appliance may check whether a re-input message is contained in the message 630 in operation S650.

In the re-input message checking process, when it is determined that the message 630 contains the re-input message, the process flow proceeds to the control command extraction process in operation S440 as shown in FIG. 4A.

In the re-input message checking process, when it is determined that there is no re-enter message, the home appliance may send a message to request the user to re-input a message to the Internet service in operation S660.

Through the above-described processes, the home appliance can operate in accordance with the user's intentions.

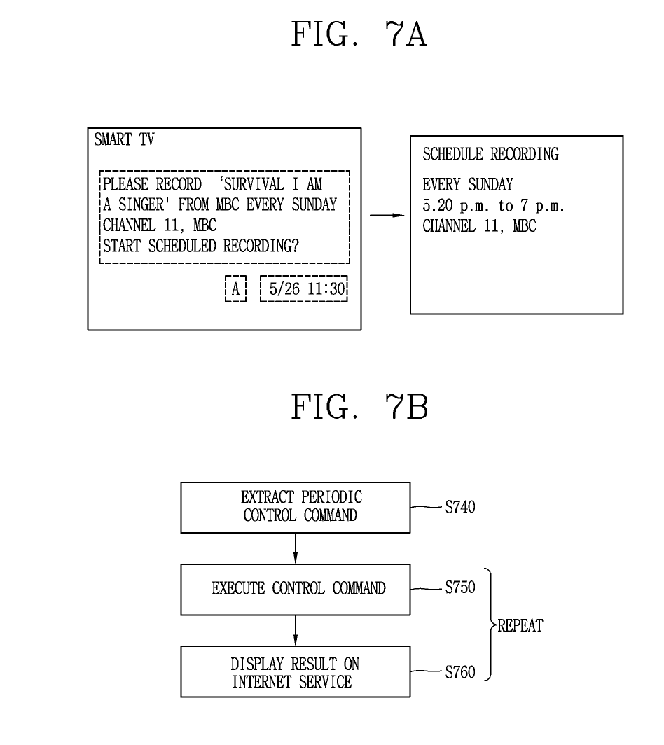

FIG. 7A is a view illustrating a case in which a message instructing a home appliance to repeat the same operation at a predetermined cycle is input. FIG. 7B is a flowchart illustrating the operation of when a control command is extracted from the message.

As shown in FIG. 7A, a user may leave a message to instruct the home appliance to repeat the same operation.

With reference to FIGS. 7A and 7B, while the control unit extracts a control command, a control command repeated at a predetermined cycle may be extracted in operation S740.

A process of executing the control command in operation S750 and a process of displaying a result of executing the control command on the Internet service in operation S760 may be repeated at a predetermined cycle.

Meanwhile, the user may input a suspension command against the command of repetition by the input unit. In addition, the user may input the details regarding the repetition to the content of the message.

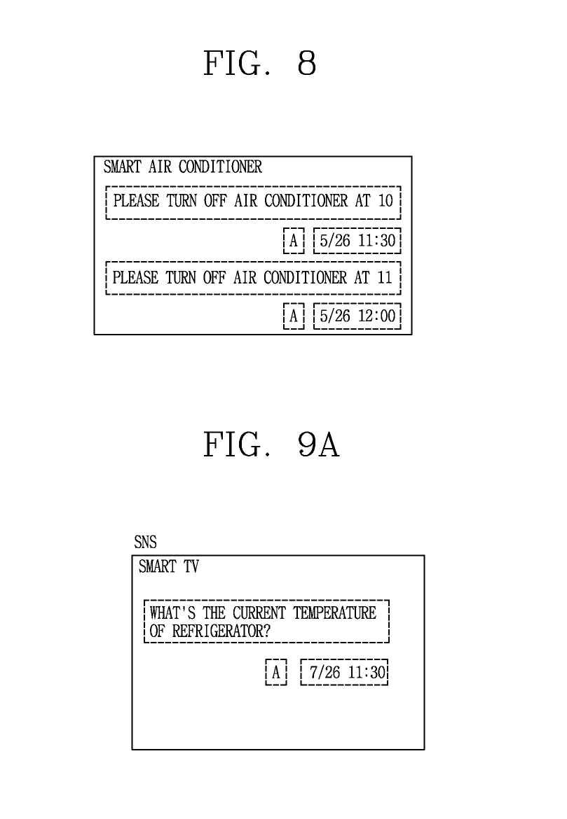

FIG. 8 is a view illustrating a case in which a user inputs home appliance operating messages with conflicting contents to SNS.

As such, in terms of processing the messages with conflicting contents in relation to the operation of the home appliance, the user may input a procedure for these messages by the input unit. Alternatively, the user may input the procedure through the Internet service.

For example, according to the setup input by the user, a message by a particular user account may take priority over a message by another user account. In addition, according to the setup input by the user, a message that is input earlier may take priority over a message that is input later. On the contrary, a message that is input later may take priority over a message that is input earlier. By using these methods, problems that may occur when several messages with conflicting contents are input can be minimized.

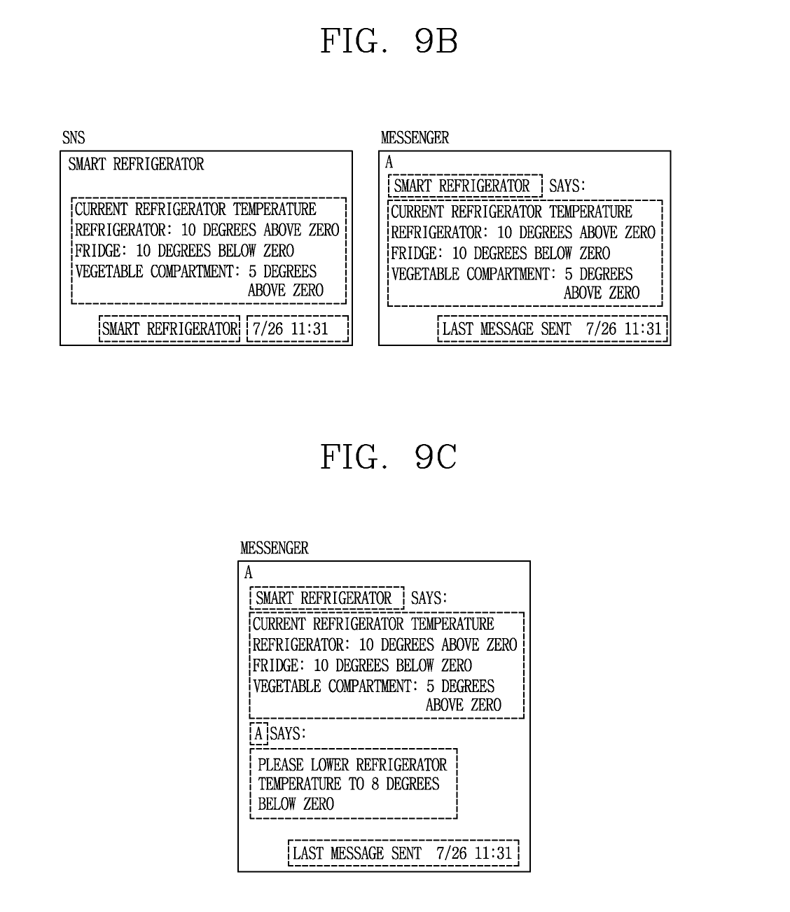

FIG. 9 is a view illustrating a case in which a user checks the status of the home appliance by using two types of Internet services to control the home appliance.

Referring to FIG. 9A, the user may request temperature information of the home appliance by SNS.

As shown in FIG. 9B, the home appliance may display status information by at least one Internet service such as SNS or messenger service upon the user's request.

With reference to FIG. 9C, the user who has checked the status information may control to lower the temperature of the home appliance by another Internet service (messenger service) other than the Internet service (SNS) by which the user has input the message requesting the temperature information of the home appliance.

Since these Internet services are accessible regardless of terminals, the user can check the status of the home appliance or control the home appliance regardless of terminals.

In addition, according to the situations of the user, an Internet service available at a particular terminal may be limited. Nevertheless, the user can send a message to the home appliance by using another Internet service other than the Internet service with limited access.

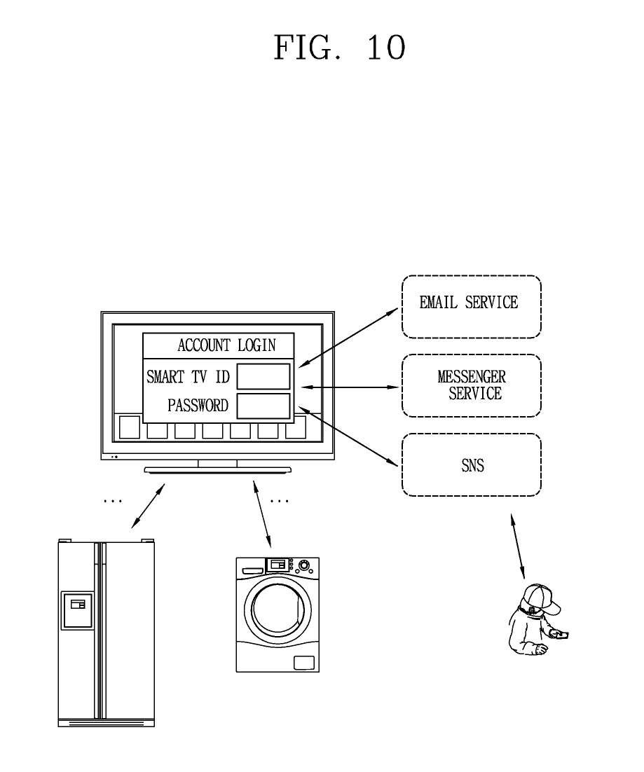

FIG. 10 is a view illustrating a system in which the operation of the home s appliance is controlled while one home appliance interoperates with other home appliances.

A home appliance 101 includes an account that is registered with Internet services by the above-described method. The account of the home appliance 101 is registered with email service, messenger service, and SNS. Therefore, the user can check the status information of the home appliance 101 by the Internet services and operate the home appliance 101.

The home appliance 101 may stay connected to other home appliances 102 and 103 by the communication unit. When the home appliance 101 stays connected with the home appliances 102 and 103, a control command that is extracted from a message left in the account of the home appliance 101 may be transmitted to the home appliances 102 and 103. This is because the home appliance 101 can determine whether a predetermined message left in the account of the home appliance 101 contains the operations of the home appliances 102 and 103 and because the home appliance 101 can extract a control command with respect to the home appliances 102 and 103 from the message and transmit the control command by the communication unit.

Therefore, the user can check status information of each of the home appliances 102 and 103 by using the Internet service page regarding the account of the home appliance 101 not by an account of each home appliance, and control the operations of the home appliances 102 and 103.

In addition, the home appliance 101 may pull together status information of each home appliance. The home appliance 101 may then transmit information, obtained by pulling together, the status information to the Internet service page regarding the account of home appliance 101. For example, a particular home appliance may pull together power consumption information of various home appliances that interoperate with the particular home appliance. Then, the particular home appliance may transmit this power consumption information to an account of the particular home appliance.

According to an embodiment of the present invention, the above-described method can be implemented as computer readable codes in program recorded media. A computer readable medium includes all types of recording devices that store data readable by computer systems. Examples of the computer readable recording medium include ROM, RAM, CD-ROM, magnetic tapes, floppy disks, and optical data storage devices. Also, the above-described method can be implemented in a carrier wave (for example, transmission through the Internet). The computers may include a controller of a mobile terminal.

According to an aspect of the invention, status information of a home appliance can be checked through the existing Internet services to operate he home appliance, thereby increasing user convenience.

According to an aspect of the invention, status information of a home appliance can be checked by various terminals to operate the home appliances.

According to an aspect of the invention, home appliance can be easily controlled remotely without installing additional remote control applications.

According to an aspect of the invention, integrated control of various home appliances can be provided, and status information of various home appliances can be pulled together and checked.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A method of operating a home appliance, the method comprising:
checking a message included in at least one of an server of Internet service and an page of Internet service while the home appliance uses an account thereof set beforehand;
authenticating the message whereby it is checked whether an account in which the message is written has a predetermined relationship with the account of the home appliance; and
executing a control command to control the home appliance according to the message, the control command analyzed based on the message.

2. The method of claim 1, wherein the checking of the message comprises logging on to the server of Internet service while the home appliance uses the account thereof set beforehand.

3. The method of claim 1, further comprising:
creating a message including at least one of collection information and status information of the home appliance; and
sending the message to display the message on the Internet service.

4. The method of claim 1, further comprising:
creating a message corresponding to a result when the home appliance executes the control command; and
sending the message to display the message on the Internet service.

5. The method of claim 4, wherein the result of executing the control command is at least one of collection information and status information of the home appliance.

6. The method of claim 1, wherein the Internet service is at least one of social network service (SNS), email service, and messenger service.

7. The method of claim 6, wherein the page of Internet service is an email received at the account of the home appliance in case of the email service, a message received at the account of the home appliance in case of the messenger service, and a website in association with the account of the home appliance in case of the social network service.

8. The method of claim 1, further comprising:
sending a confirmation message containing the control command analyzed; and
receiving a response message to the confirmation message from a user.

9. The method of claim 8, further comprising sending a message to request re-input to the Internet service.

10. The method of claim 1, further comprising:
sending a confirmation message containing a result of executing the control command; and
receiving a response message to the confirmation message from a user.

11. The method of claim 10, further comprising sending a message requesting re-input to the Internet service.

12. The method of claim 1, wherein the message is an interactive sentence.

13. A home appliance comprising:
a communication unit establishing connection to a network;
a storage unit storing information about an account of the home appliance and information about a user account stored to have a predetermined relationship with the account of the home appliance in an server of Internet service; and
a control unit functionally connected to the communication unit and the is storage unit,
wherein the control unit checks a message included in at least one of the server of Internet service and an page of Internet service by using the information about the account of the home appliance, acquires a message displayed by the user account from at least one of the server of Internet service and the page of Internet service, and executes a control command to control the home appliance according to the message while the control command is analyzed based on the message.

14. The home appliance of claim 13, wherein the control unit creates a message corresponding to a result of executing the control command and sends the message to display the message on an Internet service.

15. The home appliance of claim 13, wherein the control unit sends a confirmation message containing the control command analyzed.

16. The home appliance of claim 13, wherein the home appliance is a television, a radio, a computer, a refrigerator, a washing machine, an air conditioner, or a cleaner.
